(19) United States
(12) Patent Application Publication
(10) Pub. No.: US 2014/0268829 A1
(43) Pub. Date: Sep. 18, 2014

(54) Downward Illumination Assembly

(71) Applicant: Man-D-Tec, Inc., Scottsdale, AZ (US)

(72) Inventors: Dalton J. Mandy, Scottsdale, AZ (US); Terry R. Mandy, Paradise Valley, AZ (US); Brandon R. Mandy, Scottsdale, AZ (US)

(21) Appl. No.: 14/209,474

(22) Filed: Mar. 13, 2014

Related U.S. Application Data
(60) Provisional application No. 61/782,052, filed on Mar. 14, 2013.

(51) Int. Cl. F21V 23/02

(52) U.S. Cl. CPC F21V 23/023
USPC 362/373; 362/362; 29/825

(57) ABSTRACT

A downward illumination assembly comprising a lamp housing, a power supply module removably supported on a power supply module support surface, and an LED module carried by the lamp housing and coupled to the power supply module. The power supply module extends through an opening in the housing wall with at least a portion of the module being disposed outside the lamp housing and can be installed and removed interiorly of the lamp housing through the open lower end of the lamp housing.

### CROSS-REFERENCES TO RELATED APPLICATIONS

This patent application claims the benefit of the filing date of U.S. Provisional Patent Application Ser. No. 61/782,052, filed Mar. 14, 2013; which is incorporated herein by reference in its entirety.

### BACKGROUND

1. Field

This application relates generally to a downward illumination assembly for directing light downward from the ceiling area of a room such as an elevator passenger compartment.

2. Description of Related Art Including Information Disclosed Under 37 CFR 1.97 and 1.98 U.S. Pat. No. 7,896,517

Downward illumination assemblies present a maintenance problem when a power supply must be removed from the assembly for replacement or repair. Removal and replacement often require access to an area above the assembly and a ceiling panel upon which the assembly is mounted.

### SUMMARY

A downward illumination assembly is provided for directing light downward from the ceiling area of a room may comprise a lamp housing having a housing interior defined by a housing wall extending downwardly to an open lower end that is configured to be positioned adjacent an opening in a ceiling panel. The assembly may also comprise a power supply module. The power supply module may by removably supported in an installed position in which at least a portion of the power supply module is disposed outside the lamp housing. The lamp housing may include a power supply module receptacle opening formed in the housing wall and shaped to allow the power supply module to pass through between the installed position and the housing interior. The assembly may also comprise a power supply module support surface positioned and configured to support the power supply module as the power supply module is moved between the installed position and the lamp housing interior so that the power supply module can be installed and removed interiorly of the lamp housing through the open lower end of the lamp housing. The assembly may additionally comprise an LED module comprising an LED carried by the lamp housing and coupled to the power supply.

The assembly may alternatively comprise a lamp housing having a housing wall extending downwardly to an open lower end configured to be positioned adjacent an opening in a ceiling panel. The closed housing upper end may be generally circular in shape, the housing wall may be generally cylindrical in shape and the upper end and wall may define a downwardly opening canister. The assembly may comprise a power supply module removably supported in an installed position in which at least a portion of the power supply module is disposed outside the housing. The housing wall may include a power supply module receptacle opening spaced from the open lower end. The power supply module receptacle may be configured to allow the power supply module to be removed interiorly of the lamp housing by drawing the power supply module into the lamp housing through the aperture into a position from which the power supply module may then be removed through the open lower end of the lamp housing.

A method is also provided for removing and installing a power supply module of a downward illumination assembly that is carried by a ceiling panel. The method may include the steps of gaining access to an interior of a downward illumination assembly lamp housing through an open lower end of the lamp housing, removing a power supply module from the assembly from an installed position extending at least partially outside the housing, and doing so by passing the power supply module into the lamp housing interior and then out through the open lower end of the lamp housing, and installing a power supply module in the assembly by passing the power supply module into the housing interior through the open lower end of the lamp housing and then into its installed position on and extending at least partially outside the lamp housing.

### DRAWING DESCRIPTIONS

These and other features and advantages will become apparent to those skilled in the art in connection with the following detailed description and drawings of one or more embodiments of the invention, in which:

FIG. 1 is a perspective view of a downward illumination assembly in an assembled state and mounted on a ceiling panel in an elevator;

FIG. 2 is a perspective exploded view of the assembly of FIG. 1;

FIG. 3 is a perspective view of the assembly of FIG. 1 with a lamp module of the assembly having been removed downwardly through a lower opening of a lamp housing of the assembly, but remaining connected by electrical wiring to a power supply of the assembly;

FIG. 4 is a partially cut-away perspective view of the assembly of FIG. 1 with the power supply having been removed downwardly through the lower opening of the lamp housing of the assembly; and

FIG. 5 is a partially cut-away perspective view of the assembly of FIG. 1 with the lamp module having been removed downwardly through the lower opening of the lamp housing, and electrically disconnected from the power supply.

### DETAILED DESCRIPTION

A downward illumination assembly for directing light downward from the ceiling area of a room, such as an elevator passenger compartment, is generally shown at 10 in FIGS. 1-5. The assembly 10 may include a lamp housing 12, a power supply module 14 comprising an LED driver 16, a power supply module support surface 18, and an LED module 20 comprising an LED and carried by the lamp housing 12. The LED module 20 may be electrically coupled to the power supply module 14.

The power supply module 14 may be removably supported in an installed position in which at least a portion of the power supply module 14 is disposed outside the lamp housing 12. The power supply module 14 may include a power supply module enclosure 24 including a box portion 26 having a box opening 28 and a cover panel 30 removably securable to close a top portion of the box portion 26. The power supply module enclosure 24 may also include ventilation holes 32.

As best shown in FIG. 4, the power supply module enclosure 24 may include an electrical power port 34 that may be disposed in a radially outer one of two end panels (not shown) of the power supply module enclosure 24. A current path 38 may extend from the LED module 20 through the power supply module 14 and the electrical power port 34 and may be connectable to an electrical power source 40. In other words, the current path 38 may complete an electrical power circuit comprising the LED module 20, the power supply module 14, and the electrical power source 40.

As best shown in FIG. 1, the lamp housing 12 may have a closed upper end 42, and a housing interior defined by a housing wall 44 extending downwardly to an open lower end 46 from around a periphery of the closed upper end 42. The open lower end 46 of the lamp housing 12 may be configured to be positioned adjacent an opening 48 in a ceiling panel 50. The closed housing upper end 42 may be generally circular in shape, and the housing wall 44 may be generally cylindrical in shape. The upper end and wall of the lamp housing 12 may define, or give the housing 12 the shape of, a downwardly opening canister.

The LED module 20 may be removably fastened to the closed upper end 42 of the lamp housing 12 by two LED module fasteners 52 as best shown in FIGS. 1 and 3. Each LED module fastener 52 may include a threaded mounting post 54 carried by and extending axially downward from the closed upper end 42 of the lamp housing 12, and the LED module 20 may include two openings 56 configured and positioned to receive the respective mounting posts 54. Each LED module fastener 52 may further include a nut 53, such as, for example, a wing nut that is configured to thread onto one of the mounting posts 54 and secure the LED module 20 in its installed position. The nuts 53 may also be configured to unthread from the mounting posts 54 to free the LED module 20 for removal.

The lamp housing 12 may also include a power supply module receptacle opening 56 formed in the housing wall 44. The power supply module receptacle opening 56 may be spaced from the open lower end 46 of the housing 12, and the opening 56 may be shaped, and may be large enough, to allow the power supply module 14 to pass completely through between the installed position and the housing interior. The opening 56 may be configured to allow the power supply module 14 to be removed interiorly of the lamp housing 12 by drawing the power supply module 14 into the lamp housing 12 through the opening 56 into a position from which the power supply module 14 may then be removed through the open lower end 46 of the lamp housing 12.

As best shown in FIG. 4, the assembly 10 may include a side-mounted power supply module receptacle tray 58 carried by the housing wall 44 in alignment with the power supply module receptacle opening 56. The power supply module receptacle tray 58 may include a floor panel 60 and two side panels 62 extending integrally upward from along opposite side edges 61 of the floor panel 60. The two side panels 62 may be spaced to receive the power supply module 14 as it is moved from a position within the lamp housing 12 to the installed position between the side panels 62 on the receptacle tray 58, and to allow the power supply module 14 to be removed from the installed position on the receptacle tray 58 to a position within the lamp housing 12. The power supply module enclosure cover 30 may also be configured to be fastened to the power supply module enclosure box portion 26 without impeding sliding motion of the power supply module 14 along the power supply module receptacle tray 58.

The receptacle tray 58 may also include the power supply module support surface 18. The power supply module support surface 18 may be positioned and configured to support the power supply module 14 as the power supply module 14 is moved between the installed position and the lamp housing interior so that the power supply module 14 can be installed and removed interiorly of the lamp housing 12 through the open lower end 46 of the lamp housing 12. The power supply module 14 may be removably supported on the power supply module receptacle tray 58 such that an LED module 20 may fit within the lamp housing 12 when the power supply module 14 is in the installed position.

The power supply module receptacle tray 58 may include tray mounting tabs 64 extending circumferentially outwardly from the side panels 62 of the tray 58. The tray mounting tabs 64 may be fastened to the housing wall 44. An inner end of the power supply module 14 may include power supply module mounting tabs 66 (best shown in FIG. 4) positioned to engage the lamp housing wall 44 adjacent the power supply module receptacle opening 56. The power supply module mounting tabs 66 may be positioned to engage power supply module fasteners 68 mounted on an inner surface of the lamp housing wall 44 adjacent the power supply module receptacle opening 56.

As best shown in FIGS. 2 and 3, each power supply module fastener 68 may include a threaded mounting post 70 carried by and extending radially inward from the lamp housing wall 44, and each power supply mounting tab 66 may include an opening 71 configured to receive a threaded post 70. Each power supply module fastener 68 may further include a nut 69, such as, for example, a wing nut, that is configured to thread onto the post 70 and secure a mounting tab 66 to the lamp housing wall 44, thus securing the power supply module 14 in the installed position. The nuts 69 may also be configured to unthread from the mounting posts 70 to free the power supply module 14 for removal.

As best shown in FIGS. 1 and 2, an annular trim bezel 72 may be removably received in the lamp housing 12 in a position spanning an annular gap between an inner circumferential surface 45 of the lamp housing wall 44 and an outer circumferential surface 21 of the LED module 20. This blocks the power supply module 14, power supply module fasteners 68, and all evidence of the inward removability of the power supply module 14, from the view of an occupant of the elevator passenger compartment, below. The trim bezel 72 must be removed to view and to access and remove the power supply module fasteners 68 and to remove the power supply module 14. The trim bezel 72 may be removably held in place within the lamp housing 12 by spring clips 74. The trim bezel 72 may carry a lens 76 across an upper opening 78 of the bezel, and may include an annular pad 80 within a circumferential trough 81 formed into a lower annular flange 82 of the bezel 72. The annular pad 80 is positioned to engage a lower rim 47 of the lamp housing 12 when the trim bezel 72 is installed.

The power supply module 14 of the downward illumination assembly 10 may be removed by first removing the trim bezel 72 from the lamp housing 12 to gain access to the interior of the lamp housing 12 as shown in FIG. 2. The LED module 20 may then be removed from its installed position within the lamp housing 12 by first unscrewing the LED module fasteners 52 from the LED module mounting posts 54 and then lowering the LED module 20 through the open lower end 46 of the lamp housing 12 as shown in FIG. 4. The power supply module 14 may then be removed from its installed position on the power supply module receptacle tray 58 by disengaging the power supply module fasteners 68 releasably fastening the power supply module mounting tabs 66 to the lamp housing wall 44, i.e., by unscrewing the wing nuts 69 from the threaded power supply module mounting posts 70. The power supply module 14 may then be passed into the lamp housing interior and then out through the open lower end 46 of the lamp housing 12.

A power supply module 14 may be installed in the assembly 10 by passing the power supply module 14 into the housing interior through the open lower end 46 of the lamp housing 12 and then into its installed position on and extending at least partially outside the lamp housing 12, then releasably fastening the power supply module 14 to the housing wall 44 by engaging a power supply module fastener 68.

A downward illumination assembly constructed as described above allows easy removal for repair of replacement of bulky parts of the assembly without any need to access the assembly from above, despite the fact that the assembly extends well beyond the radius of the exposed lower end of its housing.

This description, rather than describing limitations of an invention, only illustrates an embodiment of the invention recited in the claims. The language of this description is therefore exclusively descriptive and is non-limiting. Obviously, it's possible to modify this invention from what the description teaches. Within the scope of the claims, one may practice the invention other than as described above.

1. A downward illumination assembly for directing light downward from the ceiling area of a room, the assembly comprising:
a lamp housing having a housing interior defined by a housing wall extending downwardly to an open lower end that is configured to be positioned adjacent an opening in a ceiling panel;
a power supply module removably supported in an installed position in which at least a portion of the power supply module is disposed outside the lamp housing, the lamp housing including a power supply module receptacle opening formed in the housing wall and shaped to allow the power supply module to pass through between the installed position and the housing interior;
a power supply module support surface positioned and configured to support the power supply module as the power supply module is moved between the installed position and the lamp housing interior so that the power supply module can be installed and removed interiorly of the lamp housing through the open lower end of the lamp housing; and
an LED module comprising an LED and carried by the lamp housing and coupled to the power supply.

2. A downward illumination assembly as defined in claim 1 in which the housing includes a closed upper end and the housing wall extends downwardly to the open lower end from around a periphery of the closed upper end.

3. A downward illumination assembly for directing light downward from the ceiling area of a room, the assembly comprising:
a lamp housing having a housing wall extending downwardly from an upper end to an open lower end configured to be positioned adjacent an opening in a ceiling panel, the upper end and wall defining a downwardly opening canister;
a power supply module removably supported in an installed position in which at least a portion of the power supply module is disposed outside the housing; and
the housing wall includes a power supply module receptacle opening spaced from the open lower end configured to allow the power supply module to be removed interiorly of the lamp housing by drawing the power supply module into the lamp housing through the aperture into a position from which the power supply module may then be removed through the open lower end of the lamp housing.

4. A downward illumination assembly as defined in claim 3 in which the housing wall includes a power supply module receptacle opening large enough to allow the power supply module to pass completely through the power supply module receptacle opening.

5. A downward illumination assembly as defined in claim 3 in which at least a portion of the power supply module is disposed exteriorly of the lamp housing in the installed position.

6. A downward illumination assembly as defined in claim 1 in which:
the assembly includes a side-mounted power supply module receptacle tray carried by the housing wall in alignment with the power supply module receptacle opening and including the power supply module support surface, and
the power supply module, in the installed position, is removably supported on the power supply module receptacle tray such that an LED module may fit within the lamp housing.

7. A downward illumination assembly as defined in claim 6 in which:
the power supply module receptacle tray includes a floor panel and two side panels extending integrally upward from along opposite side edges of the floor panel; and
the two side panels are spaced to receive the power supply module into the installed position between the side panels on the receptacle tray from a position within the lamp housing and to allow the power supply module to be moved from the installed position on the receptacle tray to a position within the lamp housing.

8. A downward illumination assembly as defined in claim 7 in which the power supply module receptacle tray includes at least one tray mounting tab extending circumferentially outwardly from at least one of the side panels of the tray, the tray mounting tab being fastened to the housing wall.

9. A downward illumination assembly as defined in claim 1 in which an inner end of the power supply module includes at least one power supply module mounting tab positioned to engage the lamp housing wall adjacent the power supply module receptacle opening.

10. A downward illumination assembly as defined in claim 9 in which the power supply module mounting tab is positioned to engage a power supply module fastener mounted on an inner surface of the lamp housing wall adjacent the power supply module receptacle opening.

11. A downward illumination assembly as defined in claim 10 in which:
the power supply module fastener includes a threaded post;
the mounting tab includes an opening configured to receive the threaded post; and
the power supply module fastener further includes a nut configured to thread onto the post and secure the mounting tab to the lamp housing wall and to unthread from the posts to free the power supply module for removal.

12. A downward illumination assembly as defined in claim 1 in which the power supply module includes a power supply module enclosure including a box portion having a box opening and a cover panel removably securable over to the box portion over the box opening.

13. A downward illumination assembly as defined in claim 12 in which:
the power supply module enclosure includes an electrical power port disposed in a (radially outer one of two end panels) of the power supply module enclosure; and
at least one current path extends from the LED module through the power supply module and the electrical power port and is connectable to an electrical power source (to complete an electrical power circuit comprising the LED module, the power supply module, and the electrical power source).

14. A downward illumination assembly as defined in claim 12 in which the power supply module enclosure cover is configured to be fastened to the power supply module enclosure box portion without impeding sliding motion of the power supply module along the power supply module receptacle tray.

15. A downward illumination assembly as defined in claim 12 in which the power supply module enclosure includes ventilation holes.

16. A method for removing and installing a power supply module of a downward illumination assembly that is carried by a ceiling panel, the method including the steps of:
gaining access to an interior of a downward illumination assembly lamp housing through an open lower end of the lamp housing;
removing a power supply module from the assembly from an installed position extending at least partially outside the housing, and doing so by passing the power supply module into the lamp housing interior and then out through the open lower end of the lamp housing; and
installing a power supply module in the assembly by passing the power supply module into the housing interior through the open lower end of the lamp housing and then into its installed position on and extending at least partially outside the lamp housing.

17. The method of claim 16 in which:
the method includes the additional step of providing a covering over an open lower end of the lamp housing; and
the step of gaining access to the housing interior through the open lower end of the lamp housing includes removing the covering from the assembly.

18. The method of claim 16 in which the step of removing the power supply module includes disengaging a power supply module fastener that is releasably fastening the power supply module to the lamp housing wall.

19. The method of claim 16 in which the step of returning the power supply module to its installed position includes releasably fastening the power supply module to the housing wall by engaging a power supply module fastener.
